(19) United States
(12) Patent Application Publication
(10) Pub. No.: US 2010/0060917 A1
(43) Pub. Date: Mar. 11, 2010

(54) IMAGE FORMING APPARATUS AND IMAGE FORMING METHOD

(75) Inventor: Hiroshi Watanabe, Kanagawa (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/556,016

(22) Filed: Sep. 9, 2009

Related U.S. Application Data
(60) Provisional application No. 61/095,495, filed on Sep. 9, 2008.

(51) Int. Cl. H04N 1/60; G06F 3/12

(52) U.S. Cl. 358/1.9; 358/1.15

(57) ABSTRACT

A mask processing unit masks a peripheral image of a page image in every page of an input original document, and generates an area image which is obtained by masking the peripheral image from the page image. A determining unit determines a color of the area image. When the determining unit determines that the area image is color, a printing control unit prompts a color printing processing unit to operate, and when the determining unit determines that the area image is monochrome, the printing control unit prompts a monochrome printing processing unit to operate.

### CROSS-REFERENCE TO RELATED APPLICATION

The present application claims priority under 35 U.S.C. 119 to U.S. Provisional Application Ser. No. 61/095,495, entitled AUTO COLOR SELECT APPARATUS, to Watanabe, filed on Sep. 9, 2008, the entire disclosure of which is incorporated herein by reference.

### TECHNICAL FIELD

The present invention relates to an image forming apparatus and an image forming method.

### BACKGROUND

When a control program of an image forming apparatus control processes in the unit of page, the control program analyzes the data to be printed in the unit of page, and designates a printing process regarding the printing job.

In a multi function peripheral (MFP) having a full-color printing function, the control program is divided into a color printing process and a monochrome printing process.

A color printing processing unit includes image forming units for Y (yellow), M (magenta), and C (cyan) and performs the color printing process. A monochrome printing unit includes an image forming unit for B (black), and performs the monochrome printing process.

The image forming apparatus switches the processes in the unit of page such that pages of color images are printed using the color printing processing unit, and monochrome images in the pages are printed using only the monochrome printing processing unit.

The original document may include a watermark such as a colored “confidential” therein or a color logo mark in a header/footer in some cases.

The watermark is characters, figures, or images which are formed on the original document as a background of the image to be copied in an overlapping manner.

The image forming apparatus prints the original document having color objects by prompting only the monochrome printing processing unit or both the monochrome printing processing unit and the color printing processing unit.

The image forming apparatus with an automatic color select (ACS) function determines whether the original document is color or monochrome in the unit of page, and switches the processes in every page.

The image forming apparatus selectively uses the color printing process and the monochrome printing process based on the ACS function.

However, when an original document, in which the color page and the monochrome page are mixed, is input to the image forming apparatus, the image forming apparatus may perform color printing on the page including unnecessary color objects.

When the image forming apparatus receives the page in which important sentences, photographs, or figures are monochrome and the header/footer is color, the image forming apparatus performs color printing on the page.

The image forming apparatus prints even portions of little importance for a user as color objects.

Since the image forming apparatus consumes multicolored toner in the color printing, the printing cost required when color printing is higher than the printing cost required when monochrome printing.

When the color printing process is used for the monochrome original document, the cost necessary for the process takes the same cost as the cost required when color printing.

In the past, JP-A-2000-301774 disclosed an image recording apparatus, including: determining means which determines whether or not recording target image data is color data; converting means which converts the color data into image data so as to consume a smaller amount of a color recording material instead of recording the color data as it is, when the image data to be recorded is determined to be color data by the determining means; and first recording means which performs an image recording on the basis of the image data which is converted by the converting means.

JP-A-2004-173067 disclosed a color image reading recorder, including: color/monochrome automatically determining means which determines whether read image data is color image data or monochrome image data; and control means which provides a predetermined message when the read image data is determined to be the color image data by the color/monochrome automatically determining means, and then prints the color image data when a predetermined operation is performed.

However, in the image recording apparatus disclosed in JP-A-2000-301774, all the color portions are uniformly converted into the image data which consumes a smaller amount of a color recording material. In this image recording apparatus, there are some concerns that the image quality of an important image may be degraded.

In the color image reading recorder disclosed in JP-A-2004-173067, in order to perform the color printing, the user has to operate the apparatus so as to perform the color printing within a predetermined time. In regard to the color image reading recorder, this is cumbersome for the user.

### SUMMARY

It is an object of the present invention to provide an image forming apparatus, which ignores unimportant color information in an input original document including color objects and prints the color image to be monochrome.

In an aspect of the present invention, an image forming apparatus includes: a memory which stores a page image of every page of an input original document; a color printing processing unit which performs color printing on the page image stored in the memory; a monochrome printing processing unit which performs monochrome printing on the page image stored in the memory; a mask processing unit which masks a peripheral image of the page image stored in the memory and generates an area image which is obtained by masking the peripheral image from the page image; a determining unit which determines whether a color of the area image generated by the mask processing unit is color or monochrome; and a printing control unit which prompts the color printing processing unit to print the image of the input original document when the determining unit determines that the area image is color, and prompts the monochrome printing processing unit to print the image of the input original document when the determining unit determines that the area image is monochrome.

### DESCRIPTION OF THE DRAWINGS

FIG. 1 is a view illustrating a configuration of an MFP which includes an image forming apparatus according to a first embodiment.

FIG. 2 is a plane view illustrating an imaging surface of a CCD sensor.

FIG. 3 is a block diagram illustrating an image processing unit.

FIG. 4 is a view illustrating an area for determining a color.

FIG. 5A is a flowchart illustrating a process of an input image processing unit.

FIG. 5B is a flowchart illustrating an example of a process for determining a color.

FIG. 6A is a view illustrating an input original document of which a determination object area includes a color object.

FIG. 6B is a view illustrating an input original document of which a determination object area does not include a color object.

FIG. 6C is a view illustrating paper output by an image forming apparatus which copies and outputs the input original document shown in FIG. 6A.

FIG. 6D is a view illustrating paper output by an image forming apparatus which copies and outputs the input original document shown in FIG. 6B.

FIG. 7 is a view illustrating a configuration of an MFP including an image forming apparatus according to a second embodiment.

FIG. 8 is a block diagram illustrating an analyzing unit.

FIG. 9 is a flowchart illustrating a process of an analyzing unit to print an object to be monochrome.

FIGS. 10A to 10D are views each illustrating an example of an input original document including a color watermark and a paper on which the watermark is printed in a monochrome mode.

### DETAILED DESCRIPTION

Throughout this description, the embodiments and examples shown should be considered as exemplars, rather than limitations on the apparatus and methods of the present invention.

Hereinafter, an image forming apparatus and an image forming method according to embodiments will be described in detail with reference to the accompanying drawings. In addition, the same components in the drawings are designated by the same reference numeral, and the description already give will be omitted.

### First Embodiment

The image forming apparatus according to the first embodiment is the MFP.

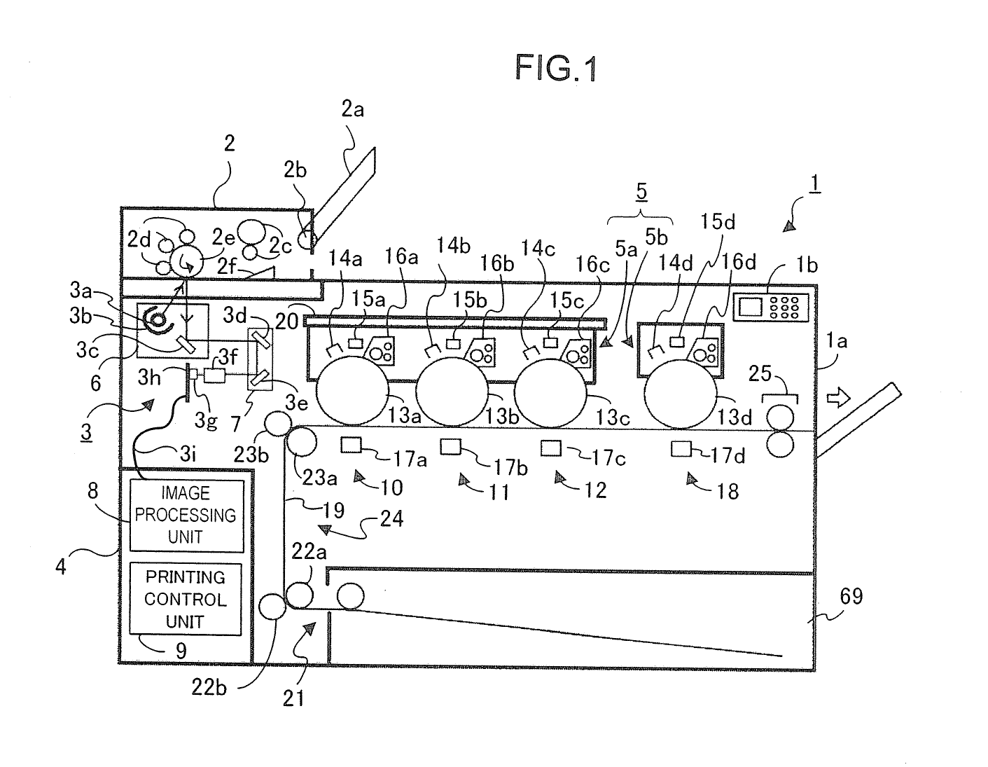

FIG. 1 is a view illustrating a configuration of the MFP which includes the image forming apparatus according to the first embodiment. The MFP 1 is provided with a housing 1a, a console panel 1b, an original document input unit 2, an image reading unit 3, a control unit 4, a printing processing unit 5, and a paper feeding unit 69.

The console panel 1b is provided at the housing 1a, and includes a display and plural buttons.

The original document input unit 2 serves to automatically send the original document which is set in an original document tray 2a.

The image reading unit 3 reads the color image in the original document which is fed by the original document input unit 2, and generates image data.

The control unit 4 processes the image data obtained from the image reading unit 3, and gives an instruction to the printing processing unit 5 to form the image. The control unit 4 is responsible for controlling the entire operations of the MFP 1.

The printing processing unit 5 is a printer engine which forms the image based on the image data and prints the image on the fed paper.

The paper feeding unit 69 is a paper feeding cassette which sets the papers therein and feeds the paper to the printing processing unit 5.

As an example, the original document input unit 2 includes rollers 2b, 2c, 2d of which rotation shafts are disposed in parallel to each other, a drum 2e which is rotatably driven in an arrow direction, and a jump base 2f which guides the original document outside the original document input unit 2.

The roller 2b picks up the original document in the original document tray 2a. A roller pair 2c transfers the original document to the drum 2e. The roller group 2d corrects a skew of the original document, and prevents the original documents from overlapping with each other. The outer peripheral surface of the drum 2e presses the original document to a platen at a reading position P.

The image reading unit 3 generates color tone information and brightness information of the image, and outputs the color tone information and the brightness information to the control unit 4. The control unit 4 determines whether the input original document is color or monochrome using the color tone information.

The image reading unit 3 creates the image data in the bitmap format for every page. The image reading unit 3 obtains information on the width W of the read original document and information on the height H of the original document from the image data.

When the shape of an original document is vertically long, the width of the original document indicates a length between the left end and the right end of the original document. The height of the original document indicates a length between the upper end and the lower end of the original document.

The function of the image reading unit 3 for generating the color tone information and the brightness information will be further described in detail.

As an example, the image reading unit 3 includes a light source 3a, a reflector 3b, mirrors 3c, 3d, and 3e, a lens 3f, a CCD (Coupled Charged Device) sensor 3g, and an image generating unit 3h.

The light source 3a outputs light which irradiates the original document. The reflector 3b reflects the light such that the light intensity on the surface of the original document is uniform. The mirror 3c guides the reflected light from the original document to the mirror 3d. The mirror 3d guides the reflected light from the mirror 3c to the mirror 3e.

The mirror 3e guides the reflected light from the mirror 3d to the lens 3f. The lens 3f collects the reflected light from the mirror 3e. The lens 3f forms an image on an imaging surface of the CCD sensor 3g according to the light collected by the lens 3f.

The CCD sensor 3g is a 4-line CCD. The CCD sensor 3g photoelectrically converts the light formed as an image for each color. The CCD sensor 3g accumulates charges for each color for a predetermined time, and then outputs the charge amount as the brightness information for each color.

The image generating unit 3h is a circuit element which generates the image data in an image pattern of a bit set.

The function of the image generating unit 3h is implemented by an LSI (Large Scale Integration), a CPU (Central Processing Unit), a ROM (Read Only Memory), and a RAM (Random Access Memory). In the ROM, information on a standard size of the original document in the country in which the MFP 1 is provided is stored.

The light source 3a, the reflector 3b, and the mirror 3c are provided at a carriage 6. The mirrors 3d and 3e are provided at a carriage 7. The carriages 6 and 7 move in the horizontal direction in the drawing due to motors and belts which are not shown in the drawing.

The moving direction of the carriages 6 and 7 correspond to the sub scanning direction of the original document. While the carriage 6 moves, the reading position P moves from the left to the right with respect to the original document.

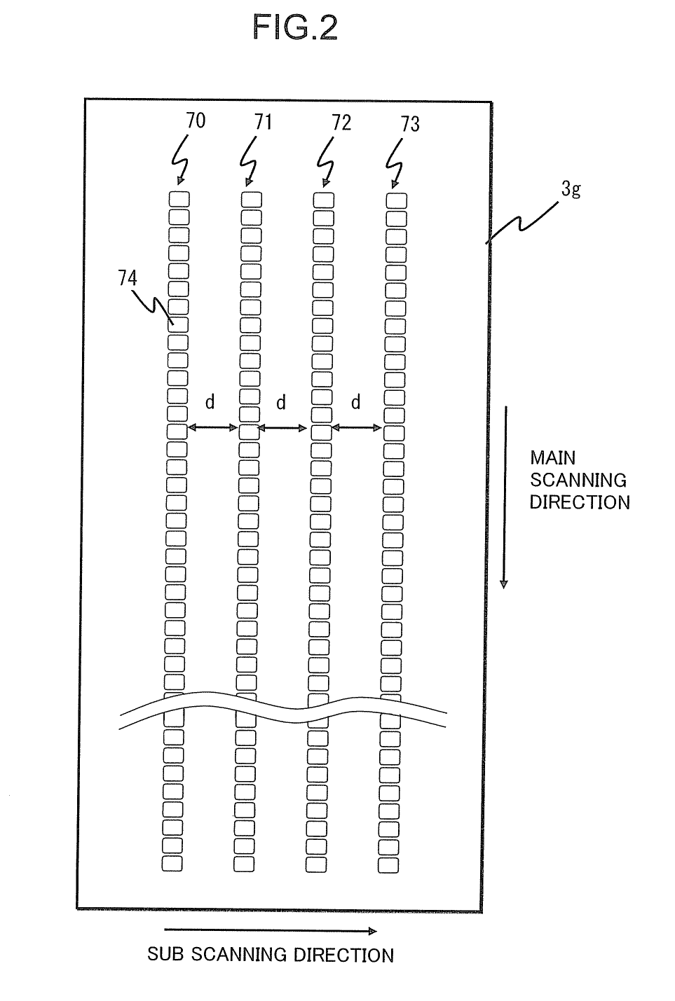

FIG. 2 is a plane view illustrating the imaging surface of the CCD sensor 3g.

The CCD sensor 3g includes an R (red) color CCD sensor 70, a G (green) color CCD sensor 71, a B (blue) color CCD sensor 72, a black and white monochrome CCD 73, and a line memory (not shown).

The R color CCD sensor 70 is configured from plural photo diodes 74 which are each disposed in a line shape in the main scanning direction. The color CCD sensor 70 includes an optical filter which allows red wavelength light to pass.

All of the photo diodes 74 in one line receive the reflected light from the image in the original document which moves in the sub scanning direction, and continuously generate the charges in the sub scanning direction.

The configurations of the G color CCD sensor 71 and the B color CCD sensor 72 are substantially the same as that of the R color CCD sensor 70. The monochrome CCD sensor 73 does not include the optical filter.

The reading position P moves in the sub scanning direction, so that, on the imaging surface of the CCD sensor 3g, the image is generated in a four-line shape of which each line extends in the main scanning direction.

The respective lines are spaced by a pitch d in the sub scanning direction. The image generating unit 3h corrects the deviation. The image generating unit 3h outputs the color tone information.

The image generating unit 3h samples the charge amount of the magnitude according to the light intensity with respect to each color, and outputs the image signals of R, G, and B. The image signal is the image information.

When the scanning of the original document is completed by the carriages 6 and 7 shown in FIG. 1, the CCD sensor 3g generates the brightness information of R, G, and B with respect to the entire original document.

The brightness information is expressed in bits, for example. The image information includes information on the intensity of each color of R, G, and B, and information on the brightness of each color of R, G, and B.

The image generating unit 3h outputs the image information to the control unit 4 via the harness 3i. The image generating unit 3h outputs each piece of information on the width and height of the image on the input original document to the control unit 4.

The control unit 4 is configured of an image processing unit 8 and a printing control unit 9. The image processing unit 8 serves as a mask processing unit and a determining unit. In the image processing unit 8 and the printing control unit 9, the CPU, the ROM, the RAM, and the LSI are used.

The image processing unit 8 converts the image data of 3 colors of R, G, and B obtained from the image reading unit 3 into the 4 printing colors of Y, M, C, and K.

In regard to the image data obtained from the image reading unit 3, the image processing unit 8 makes a determination on whether the original document is color or monochrome for each page, and outputs the color or monochrome identification information.

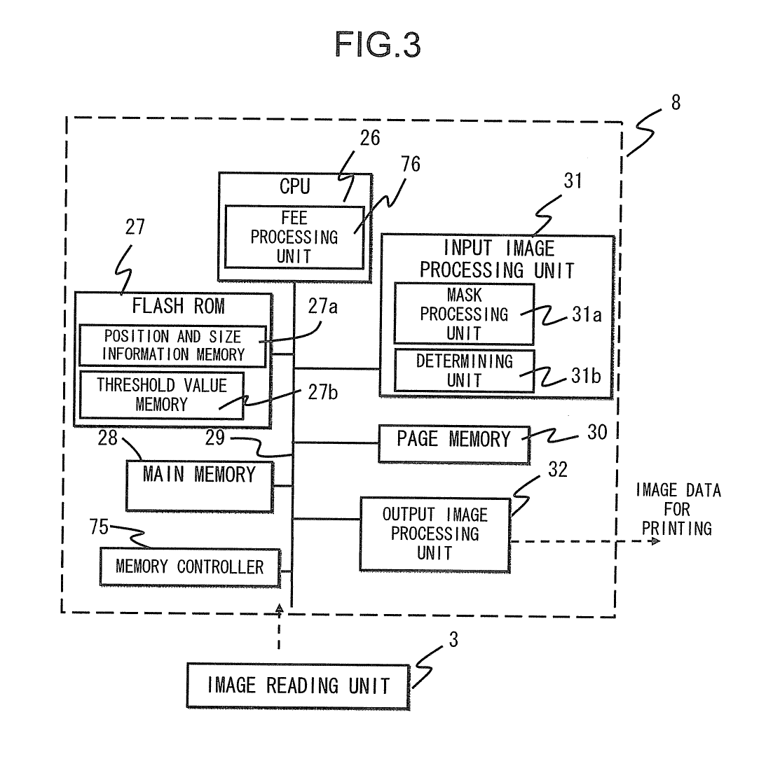

FIG. 3 is a block diagram illustrating the image processing unit 8. In the drawing, the same symbols described above represent the same components. The image processing unit 8 includes a flash ROM 27, a main memory 28, a data bus 29, a memory controller 75, and a CPU 26.

The flash ROM 27 stores information on the shape and the size of a masked image area which will be described later. The flash ROM 27 includes a position and size memory 27a and a threshold value memory 27b. The flash ROM 27 stores control programs, a variety of setting data, and parameters.

The main memory 28 is a first memory. The main memory 28 includes a large-capacity data range in which the image data input from the image reading unit 3 is stored.

The data bus 29 is used for data transmission. The memory controller 75 inputs and outputs the image data.

The CPU 26 is the MPU (Micro Processing Unit) which reads the programs and the data from the flash ROM 27, controls the entire operations of the MFP 1, and controls the operation of reading the original document.

A fee processing unit 76 is realized by the CPU 26, the flash ROM 27, and the main memory 28.

The fee processing unit 76 stores the number of times that printing is performed by the color printing processing unit 5a and the number of times that printing is performed by the monochrome printing processing unit 5b for every page to which printing is instructed. The fee processing unit 76 obtains a charging fee by multiplying the number of times of printing, which are performed by the color and monochrome printing processing unit, by a fee scale which is previously held.

The fee processing unit 76 writes the number of times of color printing, the number of times of monochrome printing, and information on the plural fee scales on the main memory 28.

The image processing unit 8 further includes a page memory 30, an input image processing unit 31, and an output image processing unit 32.

The page memory 30 is a DRAM in which records the image data of one entire page.

The input image processing unit 31 partially masks the image data of one entire page, and determines whether the image data of the unmasked area is color or monochrome. As the input image processing unit 31, the LSI is used.

The input image processing unit 31 includes a mask processing unit 31a and a determining unit 31b.

The mask processing unit 31a masks the images at the peripheral of the page image which is stored in the page memory 30, masks the peripheral images from the entire image of one page, and outputs the area image obtained by masking.

The determining unit 31b determines whether the area image generated by the mask processing unit 31a is color or monochrome.

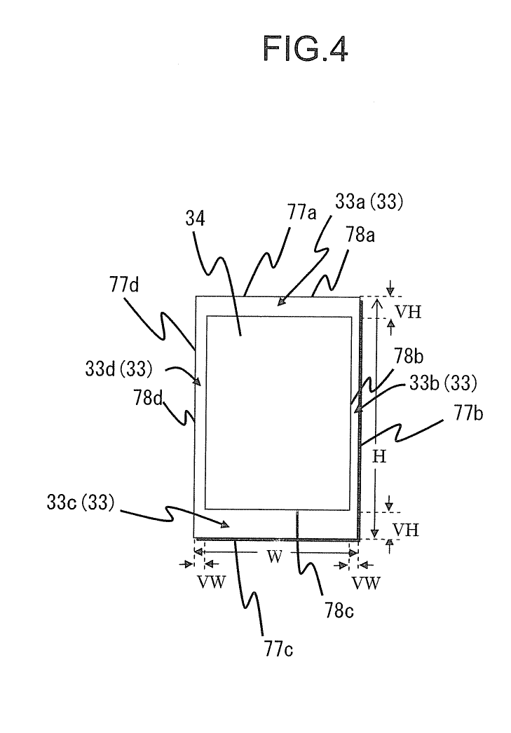

FIG. 4 is a view illustrating the area for determining the color. The outlines 77a, 77b, 77c, and 77d represent the one entire page image 33, and correspond to 4 sides of the top, bottom, left, and right ends of the input original document.

The mask processing unit 31a eliminates 4 places of the image areas 33a, 33b, 33c, and 33d, which are in a predetermined range facing the center of the image from the outlines 77a, 77b, 77c, and 77d, from the one entire page image 33.

The remaining rectangular image area 34 thus-obtained is used as the image area for determining the color or the monochrome by the mask processing unit 31a. The image area 34 is configured of the outlines 78a, 78b, 78c, and 78d.

That is, the mask processing unit 31a masks 4 places of the image areas 33a, 33b, 33c, and 33d, which are positioned outside the 4 sides of the image area 34, from the one entire page image 33. The peripheral portion of the image 33 is masked.

The width and height of the one entire page image 33 are respectively denoted as W and H. The flash ROM 27 previously holds the values of width VW and the height VH as shown in the drawing of the image areas 33a, 33b, 33c, and 33d to be eliminated.

The respective values of the width and the height are determined by the shape and the size of the watermark and the header/footer which both have a high possibility of being attached to the original document. For example, the width and the height are determined by the maximum horizontal length and the maximum vertical length, which are of the mark of the watermark or the header/footer on the paper.

The values of the width and the height are about several centimeters. The values are determined through experiment.

In addition, the determining unit 31b obtains luminance, brightness, and color tone of the surface of the original document from the data of each R, G, and B signal. The determining unit 31b has a function of identifying the color or the monochrome of the image area 34.

For example, the determination by the determining unit 31b is carried out by dividing up the image area 34. The determining unit 31b divides up the image area 34 into plural small areas (not shown), counts the number of the color pixels in each small area, and compares the count value of the obtained color pixel with a predetermined threshold value.

When the counted value is larger than the threshold value, the determining unit 31b determines that the color of the image area 34 is color. When the counted value is equal to or less than the threshold value, the determining unit 31b determines that the color of the image area 34 is monochrome.

In FIG. 3, the determining unit 31b outputs the determined result to the data bus 29 as the threshold value signal representing the color or the monochrome, and writes the image data of one page, which is the determination object, on the page memory 30.

The input image processing unit 31 performs the gamma correction, compression/extension, concentration adjustment, filtering, magnification/reduction, position adjustment or the like.

When the threshold value signal represents color, the output image processing unit 32 instructs the color printing processing unit 5a to perform color printing. When the threshold value signal represents monochrome, the output image processing unit 32 instructs the monochrome printing processing unit 5b to perform monochrome printing. As the output image processing unit 32, the LSI is used.

The instruction of printing performed by the output image processing unit 32 is performed by outputting a voltage signal to increase or decrease the amount of toner. The output image processing unit 32 outputs the voltage signal, which corresponds to the value according to the amount of toner, to the respective image forming units of the color printing processing unit 5a and the monochrome printing processing unit 5b.

The printing control unit 9 shown in FIG. 1 controls the reading of the original document by the original document input unit 2 and the image reading unit 3, and controls the operation of the printing processing unit 5.

When the image processing unit 8 determines that the original document is color, the printing control unit 9 prompts the color printing processing unit 5a to print the image of the input original document. When the color printing processing unit 5a determines that the original document is monochrome, the printing control unit 9 prompts the monochrome printing processing unit 5b to print the image of the input original document.

The printing processing unit 5 is provided with the color printing processing unit 5a which transfers and prints the respective 3 color toner images on the paper, and the monochrome printing processing unit 5b which transfers and prints the monochrome toner image on the paper.

The color printing processing unit 5a is provided with an image forming unit 10 for yellow, an image forming unit 11 for magenta, and an image forming unit 12 for cyan.

The image forming unit 10 includes: a photoconductive drum 13a which is configured with a photoconductive layer on its cylindrical outer peripheral surface and is rotatably driven; a charging unit 14a which uniformly charges the outer peripheral surface of the photoconductive drum 13a; and an exposure unit 15a which has a laser light source and irradiates the laser beam, which is modulated by the image data, on the photoconductive drum 13a.

The image forming unit 10 includes: a developing unit 16a which uses a developer to makes a visualization of an electrostatic latent image on the photoconductive drum 13a; and a transfer unit 17a which sends the print paper to the photoconductive drum at predetermined timing and transfers the developer visualization on the paper.

The image forming unit 11 includes a photoconductive drum 13b, a charging unit 14b, an exposure unit 15b, a developing unit 16b, and a transfer unit 17b. The image forming unit 12 includes a photoconductive drum 13c, a charging unit 14c, an exposure unit 15c, a developing unit 16c, and a transfer unit 17c.

The photoconductive drums 13b and 13c are substantially the same as the photoconductive drum 13a. The charging units 14b and 14c are substantially the same as the charging unit 14a. The exposure units 15b and 15c are substantially the same as the exposure unit 15a. The developing units 16b and 16c are substantially the same as the developing unit 16a.

The monochrome printing processing unit 5b includes an image forming unit 18 for black. The image forming unit 18 includes a photoconductive drum 13d, a charging unit 14d, an exposure unit 15d, a developing unit 16d, and a transfer unit 17d.

The photoconductive drum 13d is substantially the same as the photoconductive drum 13a. The charging unit 14d is substantially the same as the charging unit 14a. The exposure unit 15d is substantially the same as the exposure unit 15a. The developing unit 16d is substantially the same as the developing unit 16a.

The directions of the rotation shafts of the photoconductive drums 13a, 13b, 13c, and 13d are perpendicular to the direction of the paper 19 to be transported. The image forming units 10, 11, 12, and 18 are disposed along the direction of the paper 19 to be transported.

In addition, a frame 20 is attached to the color printing processing unit 5a. The frame 20 is a member which moves the color printing processing unit 5a up and down with respect to the housing 1a. The frame 20 is moved up and down by an elevation mechanism (not shown).

As an example, the elevation mechanism function is realized by: a spring one end of which is fixed to the housing 1a and the other end of which creates a downward push force on the frame 20; plural cams with each of their outer peripheral surfaces coming into contact with the frame 20; and motors shafts of which are attached to the eccentricity of the cams.

When the motor turns the shaft by a predetermined angle, the cams are rotated, and the frame 20 is pressed upward against the elastic force of the spring. The photoconductive drums 13a, 13b, and 13c ascend. When the frame 20 is pressed downward by the rotation of the cams, the photoconductive drums 13a, 13b, and 13c descend.

Alternatively, the frame 20 may be provided with a mechanism for inclining the frame 20 with respect to the horizontal surface. The mechanism is configured of the motor, the cams, the spring, and the like.

The frame 20 has an end portion on the side of the image forming unit 10 and an end portion on the side of the image forming unit 12. When the frame 20 is inclined, the mechanism has a pushing force on both the end portions of the frame 20 in directions opposite to each other.

The mechanism inclines the positioning of the frame 20 such that the end portion on the side of the image forming unit 10 descends and the end portion on the side of the image forming unit 12 ascends.

In addition, the paper feeding unit 69 is provided at the lower portion of the housing 1a. The paper feeding unit 69 sets the plural papers 19 therein. The paper feeding unit 69 is configured to be attachable to and detachable from the housing 1a.

The paper feeding unit 69 has an opening 21 in the end portion near the control unit 4. In the vicinity of the opening 21, pickup rollers 22a and 22b are provided. The pickup rollers 22a and 22b pick up the papers 19 in the paper feeding unit 69 one by one.

Above the pickup rollers 22a and 22b, register rollers 23a and 23b are provided. The register rollers 23a and 23b match the leading end of the paper 19 with the leading end of the toner image which is formed on the photoconductive drum 13a of the image forming unit 10.

A mechanism 24 for transporting the paper is configured from a driving roller (not shown), a driven roller (not shown), a motor (not shown) for driving the roller, the pickup rollers 22a and 22b, and the register rollers 23a and 23b. The printing control unit 9 controls the operations of the mechanism 24.

The paper 19, on to which the 4 color toner images are transferred by the color printing processing unit 5a and the monochrome printing processing unit 5b, is transported to a fixing unit 25.

The fixing unit 25 heats the paper 19 to a predetermined temperature, melting the toner image on the paper 19, and fixing the toner image on the paper 19.

In addition, the display of the console panel 1b displays a user interface (UI) screen which is generated by the control program. The console panel 1b displays plural menu items in the UI screen. The console panel 1b displays selection items and input value items, and thus prompts the user to input.

The operations of the MFP 1 having the above-mentioned configuration will be described.

When the user puts the original document in the original document tray 2a, the original document input unit 2 generates and outputs the image data from the original document. Alternatively, when the user sets a bunch of the original documents in the original document tray 2a, the original document input unit 2 takes in the original document one by one.

The image reading unit 3 reads the original document from the original document input unit 2. The image processing unit 8 of the control unit 4 performs an image process on the read image one page at a time, and each original document is determined whether it is color or monochrome.

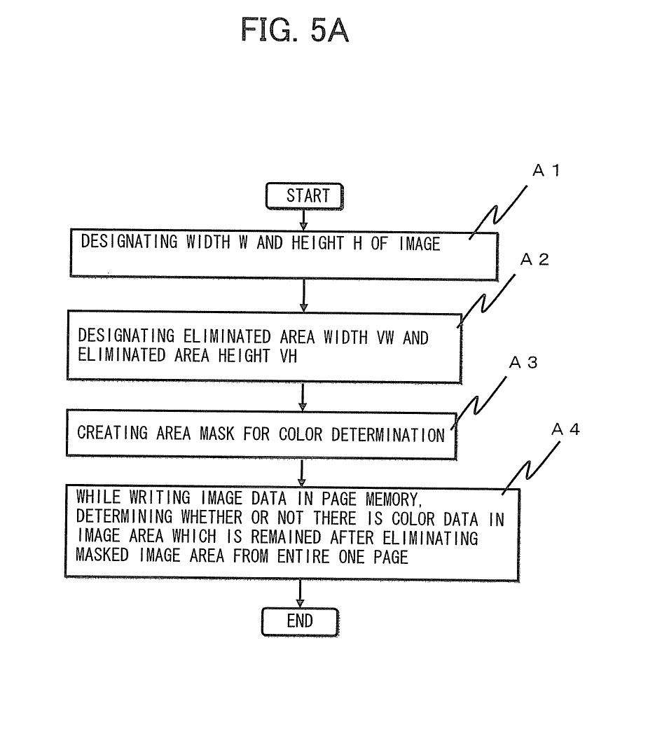

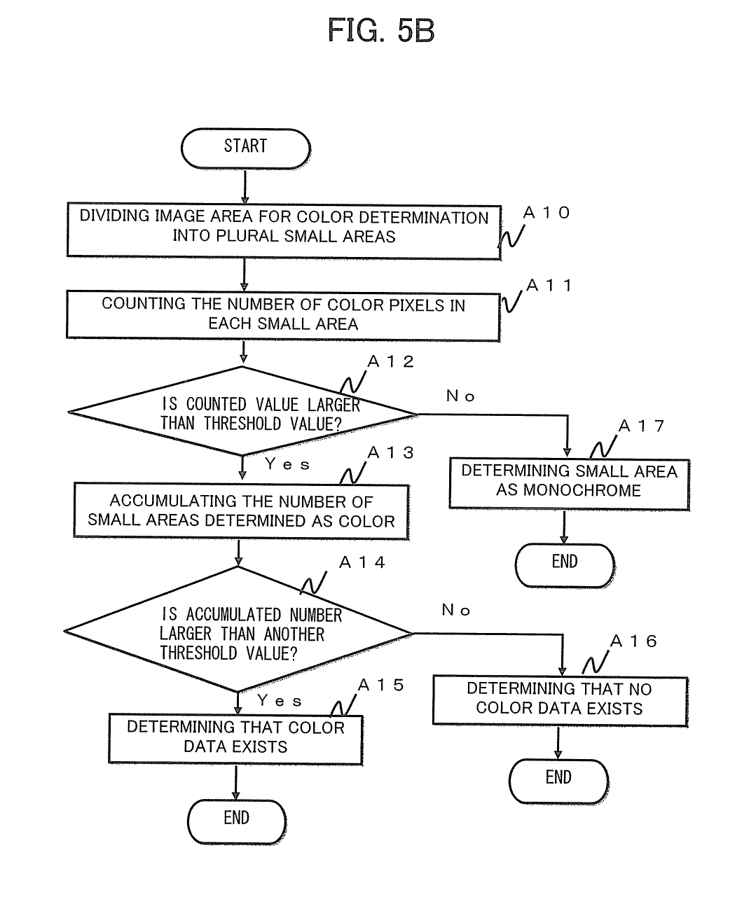

FIG. 5A is a flowchart illustrating a process of the input image processing unit 31.

In Act A1, the input image processing unit 31 receives the width W of the image and the height H of the image from the original document input unit 2 or the image reading unit 3.

In Act A2, the CPU 26 reads out the area width VW to be eliminated and the area height VH to be eliminated which are stored in the flash ROM 27, and sets the area width and the area height to the input image processing unit 31.

In Act A3, the input image processing unit 31 generates a mask and generates the image area 34 for determining the color. As shown in FIG. 4, the image area 34 is created inside of the one entire page image 33.

The input image processing unit 31 treats the peripheral area of the original document as a noneffective area, and treats the inside area of the original document as an effective area.

After the input image processing unit 31 creates the image area 34 for determining which is designated by the values W, VW, H, and VH, the CPU 26 receives the rasterized image data from the image reading unit 3.

In Act A4 shown in FIG. 5A, the CPU 26 writes the received image data on the page memory 30. The input image processing unit 31 determines whether or not there is color data in the image area 34.

FIG. 5B is a flowchart illustrating an example of a process for determining a color.

In Act A10, the input image processing unit 31 divides the image area for determining color into plural small areas, and in Act A11, counts the number of color pixels in each small area. The flash ROM 27 stores in advance plural types of threshold values which are represented by percent value.

In Act A12, the input image processing unit 31 compares the magnitudes of the values. In Act A12, when the counted value is larger than the threshold value, the input image processing unit 31 determines that the small area is color.

The procedure proceeds to the Yes route in Act A12, and in Act A13, the input image processing unit 31 accumulates the number of the small areas which are determined as color.

Subsequently, in Act A14, the input image processing unit 31 compares the accumulated number with another threshold value.

In Act A14, when the accumulated number is larger than the other threshold value, the procedure proceeds to the Yes route, and in Act 15 the input image processing unit 31 determines that there is color data in the image area 34, and then the determination process is complete.

In Act A14, when the accumulated number is equal to or less than the other threshold value, the procedure proceeds to the No route, and in Act A16, the input image processing unit 31 determines that there is no color data in the image area 34, and then the determination process is complete.

In Act A12, when the counted value is equal to the threshold value or the counted value is less than the threshold value, the procedure proceeds to the No route, and in Act A17, the input image processing unit 31 determines that the small area is monochrome, and then the determination process is complete.

The input image processing unit 31 stores the information on the determination result in the memory (not shown) in the input image processing unit 31.

At a point of time when the input image processing unit 31 receives the one entire page image data, the CPU 26 reads out the determination result on the existence of the color data from the input image processing unit 31.

Next, the process after the input image processing unit 31 writes the rasterized one page image data on the page memory 30 will be described.

When the input image processing unit 31 determines that there is color data, the CPU 26 gives the instruction to the elevation mechanism shown in FIG. 1 to shift to the lower side.

The elevation mechanism descends the frame 20, and the color printing processing unit 5a comes into contact with the paper 19. The color printing processing unit 5a is in a state in which the color printing can be performed on the paper 19.

While the image data of the page memory 30 is not subjected to any process by the output image processing unit 32, the CPU 26 passes the image data to the color printing processing unit 5a and the monochrome printing processing unit 5b.

The paper 19 is fed from the paper feeding cassette. The color printing processing unit 5a and the monochrome printing processing unit 5b sequentially print the image on the paper 19.

In addition, when the input image processing unit 31 determines that there is no color data, the CPU 26 gives the instruction to the elevation mechanism to shift to the upper side. The elevation mechanism ascends the frame 20, and the color printing processing unit 5a is raised. The color printing processing unit 5a is separated from the path through which the paper 19 is transported.

The CPU 26 sets the output image processing unit 32 such that the monochrome process is performed. The CPU 26 transmits the image data in the page memory 30 to the output image processing unit 32.

The output image processing unit 32 eliminates the color information of the image data from the image data which is stored in the page memory 30.

The output image processing unit 32 reads only the brightness information from the image data, and transmits the data obtained by making the page data be monochrome to the monochrome printing processing unit 5b.

The CPU 26 instructs the mechanism 24 to feed the paper 19 from the paper feeding unit 69. The monochrome printing processing unit 5b prints the monochrome image on the paper 19.

The fee processing unit 76 counts up the number of times of printing from the number of times of receiving the identification signal. The fee processing unit 76 stores the charging fee, which is obtained by multiplying each number of printing times by any fee scale, to the main memory 28.

The process described above is performed on all the pages of the document.

As described above, when there is a color object of little importance in the original document, the MFP 1 prints the original document by the monochrome printing process.

The MFP 1 is configured such that the unnecessary color information is ignored so as to make the input original document be monochrome.

Since the monochrome printing processing unit 5b is operated on the original document which includes the color object, the toner of the color printing processing unit 5a is not consumed.

Since the original document to be processed by the color printing process is processed by the monochrome printing process, it is possible to suppress the printing cost required when color printing.

The printing output result when the input original document of two continuous pages is set in the original document tray 2a will be described.

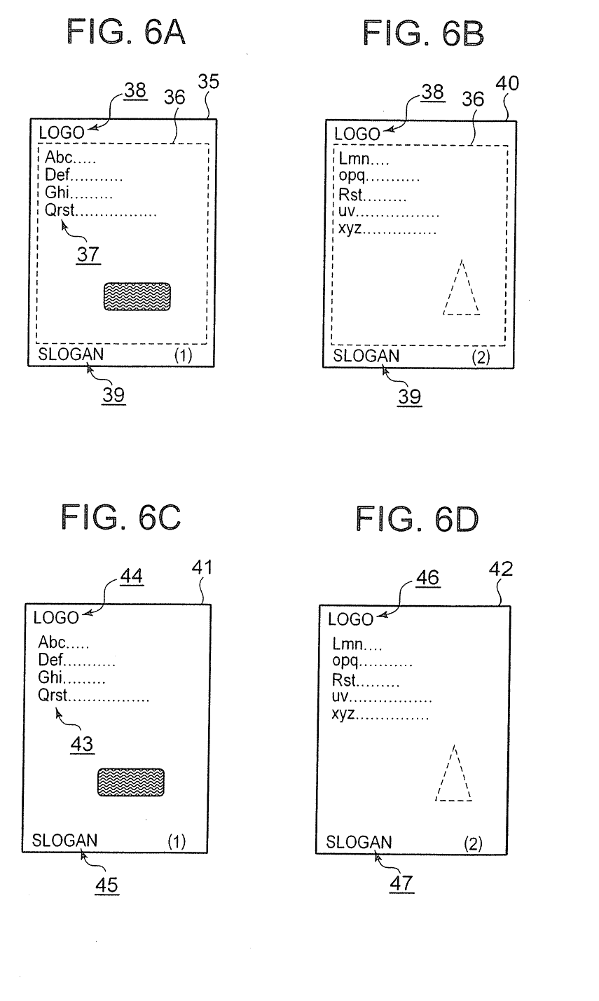

FIG. 6A is a view illustrating a first page of the input original document. FIG. 6B is a view illustrating a second page of the input original document. In FIGS. 6A and 6B, the same reference numerals denote the same components, and the page number is attached at the lower right on each page.

Both the input original document 35 shown in FIG. 6A and the input original document 40 shown in FIG. 6B are the paper on which the color and the monochrome objects are printed.

The input original document 35 has a color object 37 in the image area 36 for determining color. The input original document 35 also has color objects 38 and 39 on the eliminated area outside the image area 36.

The input original document 40 has the color objects 38 and 39 outside the image area 36, but does not have a color object in the image area 36.

FIG. 6C is a view illustrating the paper output by the MFP 1 which copies and outputs the input original document 35 shown in FIG. 6A. FIG. 6D is a view illustrating the paper output by the MFP 1 which copies and outputs the input original document 40 shown in FIG. 6B. The same reference numerals in FIGS. 6C and 6D denote the same components.

As shown in FIG. 6C, the color object 43 is printed on the position of the paper 41 corresponding to the position of the color object 37 shown in FIG. 6A. The color objects 44 and 45 are printed also at the upper end and the lower end of the paper 41.

As shown in FIG. 6D, the monochrome objects 46 and 47 are printed at the upper end and the lower end of the paper 42. The color objects 38 and 39 of the input original document 40 shown in FIG. 6B are printed to be monochrome.

The color objects 38 and 39 are included in the input original document 40 shown in FIG. 6B, but the MFP 1 eliminates the color information of the color objects 38 and 39. In the paper 42, the monochrome objects 46 and 47 having the same shape as that of the color objects 38 and 39 are displayed as the output result.

Therefore, as a result, the peripheral portions of 4 sides of the input original document 40 are printed to be monochrome.

As described above, among the input original documents 35 and 40 of two continuous pages, the color data of the second page is printed to be monochrome.

Regardless of the number of the input original document which is set in the original document tray 2a, all the pages are subjected to the determination of whether each page is color or monochrome, and when being determined as the monochrome, the page is printed to be monochrome.

The cost required when printing in color is about four times larger than that required when printing in monochrome. As shown in FIG. 6D, since the monochrome printing process is applied to the color input original document 40, it is possible to suppress the color toner consumed. The MFP 1 also contributes to the decrease in the cost required when color printing.

### Second Embodiment

The image forming apparatus according to a second embodiment is the MFP which can perform network printing.

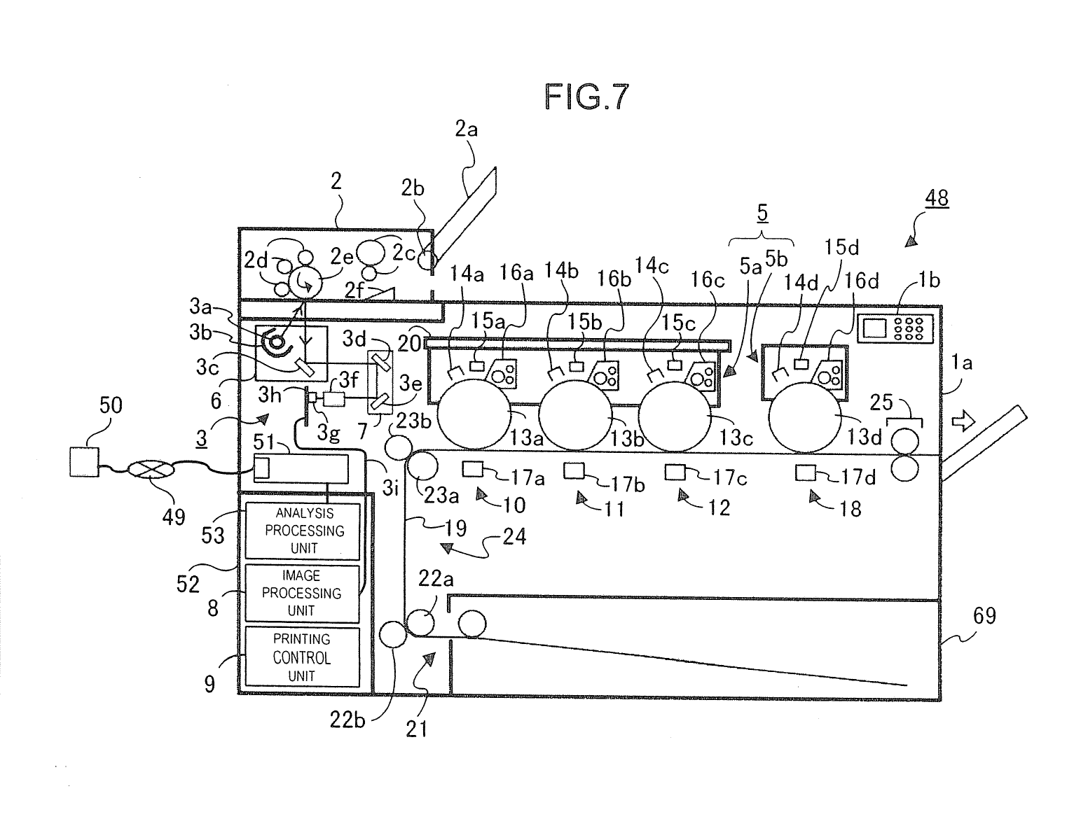

FIG. 7 is a view illustrating a configuration of the MFP including the image forming apparatus according to the second embodiment. The components with the same reference numerals as those described above designate the same components.

The MFP 48 receives the image data configured of plural pages including a page which has the color object. When there is a color object, the MFP 48 prints the color object to be monochrome.

The MFP 48 is provided with a network communicating device 51 connected to the computer 50 via a network 49 and a control unit 52 performing data reception, image process, and printing control.

The network 49 is a LAN (Local Area Network). The network 49 is connected to another computer on which a spooler is mounted.

The computer 50 converts the document to be transmitted into a command data array for the image drawing. The command is information such as figures constituting one page, positions of characters, sizes, lengths.

The computer 50 converts the command into PDL (Page Description Language) data which is represented in the format of PDL.

The computer 50 creates a printing job which includes the PDL data and the header, and registers the printing job on the spooler.

The network communicating device 51 extracts the PDL data from the printing job received from the spooler, and transmits the PDL data to the image processing unit 8.

The control unit 52 includes the image processing unit 8, the analysis processing unit 53, and the printing control unit 9.

The analysis processing unit 53 includes a rasterizing function and a function of determining whether or not the same color objects are included in adjacent pages in the received PDL data.

When the analysis processing unit 53 determines that a color object is included, the printing control unit 9 prompts the analysis processing unit 53 to make the color object of the image data be monochrome, and prompts the color printing processing unit 5a to print the image of the obtained image data.

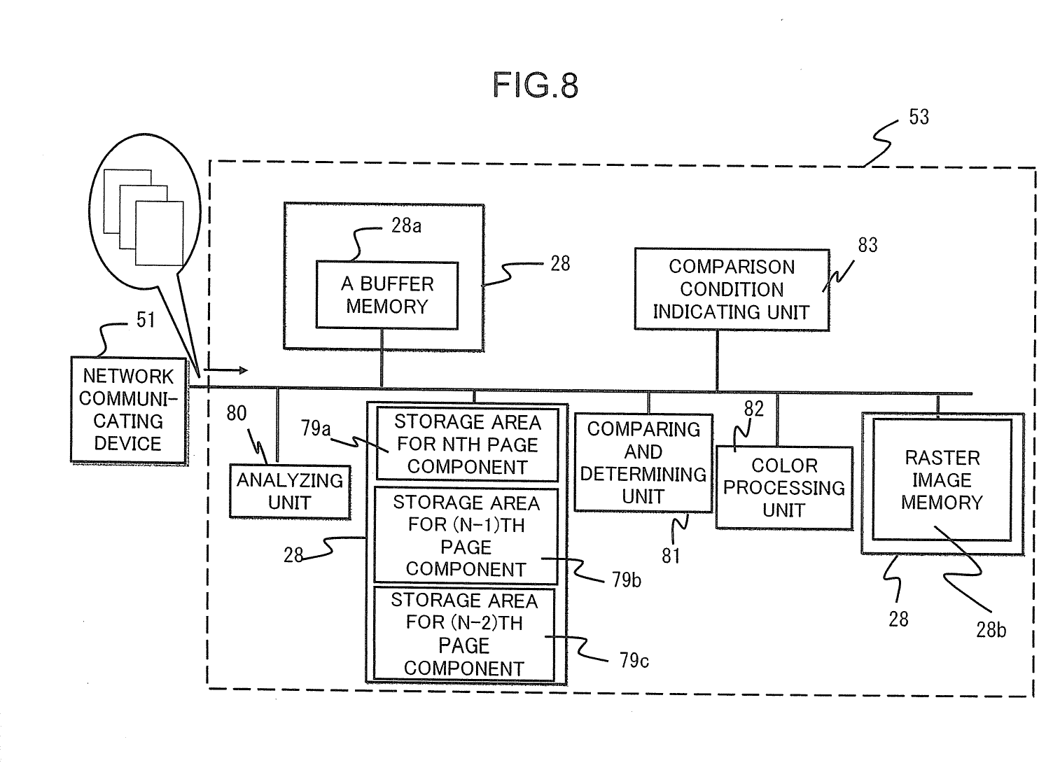

FIG. 8 is a block diagram illustrating the analysis processing unit 53. The above-mentioned reference numerals in the drawing designate the same components.

The main memory 28 assigns a memory area to a buffer memory 28a, a raster image memory 28b, a storage area 79a for the nth page component, a storage area 79b for the (n−1)th page component, and a storage area 79c for the (n−2)th page component.

The buffer memory 28a is a second memory. The buffer memory 28a stores the image data of plural pages which is received by the network communicating device 51.

The raster image memory 28b is a third memory. The raster image memory 28b stores bitmap image data in the unit of page which is obtained from the image data of the plural pages in the buffer memory 28a by the following analysis.

The analysis processing unit 53 includes an analyzing unit 80, a comparing and determining unit 81, a color processing unit 82, and a comparison condition indicating unit 83.

The analyzing unit 80 is a rasterizer. The analyzing unit 80 analyzes the image data of the plural pages in the buffer memory 28a so as to generate the bitmap image of the raster image memory 28b.

The comparing and determining unit 81 compares and determines whether or not the same color objects are included in the continuous pages analyzed by the analyzing unit 80. The comparing and determining unit 81 compares data of the 3 types of the storage areas 79a, 79b, and 79c.

The storage area 79a for the nth page component stores the PDL data of the nth page. The storage area 79b for the (n−1)th page component stores the PDL data of the (n−1)th page. The storage area 79c for the (n−2)th page component stores the PDL data of the (n−2)th page.

The comparing and determining unit 81 compares the PDL data of three continuous pages, and determines whether or not the same color objects are included in the three pages.

The color processing unit 82 eliminates the color information from the color objects which are included in the image data of the plural pages in the buffer memory 28a. The color processing unit 82 converts the characteristics information of the color object from color to monochrome.

The comparison condition indicating unit 83 has a function of setting the comparison conditions of the comparing and determining unit 81.

The analysis processing unit 53 is configured of the CPU, the ROM, the RAM, the LSI, and the like.

In the second embodiment, the MFP 48 is characterized in that there are provided with the comparing and determining unit 81, the storage areas 79a to 79c for storing the PDL data of 3 pages, and the color processing unit 82.

For example, when it is determined that a red rectangular logo mark or a red character array “confidential” are positioned on the same position of the (n−1)th page and the nth page, the comparing and determining unit 81 makes the color information of the logo mark or the “confidential” in the raster image memory 28b be monochrome.

When the color object of little importance is included in the original document, the MFP 48 prints the original document by the monochrome printing process.

The network communicating device 51 of the MFP 48 configured as described above receives the printing request and the PDL data such as PostScript (registered trademark) from the external computer 50.

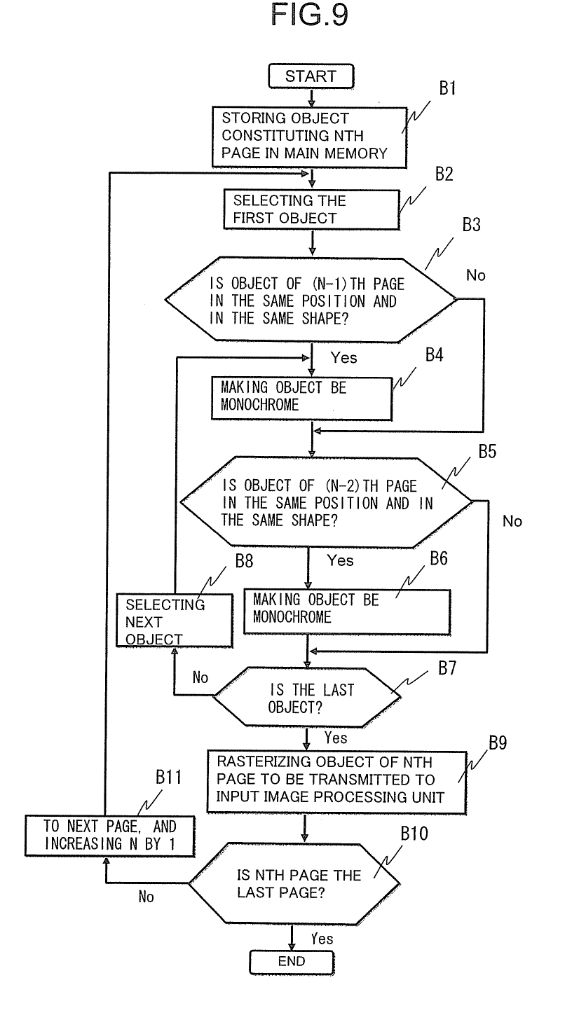

FIG. 9 is a flowchart illustrating a process of the analysis processing unit 53 to print an object to be monochrome.

In Act B1, the analyzing unit 80 reads the PDL code from the main memory 28 at any time, and analyzes the PDL code.

The PDL data is configured of the drawing command and the control command array. The drawing command indicates the character information, the figure pattern information, and the graphic information.

The character information is a font, a size, and the like. The figure pattern information is a circle, a triangle, a rectangular, a curve, and the like. The graphic information is a start position, an end position, and a direction when a line drawing is drawn.

For example, as for a circle, the center value of the circle in the x, y coordinates of which the origin of the coordinates is the upper left of the original document, and the magnitude information of the radius are included in the command.

In Act B2, the analyzing unit 80 selects, for example, the red rectangular line drawing as a comparing object among the plural objects included in the nth page.

In Act B3, the analysis processing unit 53 compares the nth page with the (n−1)th page.

The comparison process is performed by searching whether or not the object with the same shape is described in the same position in the (n−1)th page as the position of the object selected in the nth page.

In Act B3, when there is a color object with the same shape, the procedure proceeds to the Yes route, and in Act B4 the analysis processing unit 53 makes the color object be monochrome.

When receiving the instruction for converting the color object into the monochrome object from the comparing and determining unit 81, the color processing unit 82 eliminates the color information of the object in the storage area 79a for the nth page component.

Since the analysis processing unit 53 eliminates the data which has the color information among the color information and the brightness information of the object, the red rectangular line drawing is converted into the monochrome rectangular line drawing, for example.

When there is no object with the same shape after Act B4 or in Act B3 (No route), the procedure proceeds to Act B5.

In Act B5, the analysis processing unit 53 compares the nth page and the (n−2)th page. The analysis processing unit 53 searches whether or not the red rectangular line drawing is described in the (n−2)th page.

The comparison process is performed by searching whether or not the object with the same shape is described in the same position in the (n−2)th page as the position of the object selected in the nth page.

In Act B5, when the analysis processing unit 53 determines that there is a color object with the same shape, the procedure proceeds to the Yes route, and in Act B6 the analysis processing unit 53 makes the object be monochrome.

When there is no object with the same shape after Act B6 or in Act B5 (No route), the procedure proceeds to Act B7.

In Act B7, the analysis processing unit 53 determines whether or not there is an object in the 3 pages which is not yet subjected to the searching process among all the objects stored in the main memory 28.

In Act B7, when the searching process is not yet performed for the 3 pages, the procedure proceeds to the No route, and in Act B8 the analysis processing unit 53 selects another object from the main memory 28.

For example, a red character array is selected as another object instead of the red rectangular line drawing.

The analysis processing unit 53 performs a process of Act B3 on the red character array. The analysis processing unit 53 searches whether or not the red characters are described by comparing the objects among the nth page, the (n−1)th page, and the (n−2)th page.

The analysis processing unit 53 compares 3 pages in regard to all the objects stored in the main memory 28.

When the analysis processing unit 53 determines that there is a color object in the same position in the nth as in the (n−2)th pages, the analysis processing unit 53 makes the object be monochrome.

Once again, in Act B7, the analysis processing unit 53 determines whether or not there is an object in 3 pages which are not yet subjected to the searching process.

When determining that the searching process is complete in regard to all the objects, the analysis processing unit 53 determines that the target object is the last object, and the procedure proceeds to Act B9 through the Yes route.

In Act B9, the analysis processing unit 53 rasterizes the object of the nth page, and transmits the rasterized data to the input image processing unit 31 of the image processing unit 8.

In Act B10, the analysis processing unit 53 determines whether or not the nth page is the last page. When the nth page in processing is the last page, the procedure proceeds to the Yes route, and the analysis processing unit 53 terminates the process.

In Act B10, when there is another page to be processed, the procedure proceeds to the No route, and in Act B11 the analysis processing unit 53 increases the value of n by one, and performs the process of Act B1 on the (n+1)th page.

As a result, the analysis process is complete on all the received PDL data of n pages.

Sequentially, the image processing unit 8 generates the image data for printing from the bitmap image data on the main memory 28 on the basis of the command associated with each object.

When the image processing unit 8 determines that the page is monochrome, the monochrome printing processing unit 5b prints the monochrome image on the paper 19.

Summarizing the above-mentioned description, the analysis processing unit 53 compares the objects of the nth pages with the objects of the respective (n−1)th and (n−2)th pages.

When there are objects with the same shape in the same position in the nth page and the (n−1)th page and the objects are color, the analysis processing unit 53 makes the objects of the nth page be monochrome.

Similarly, the analysis processing unit 53 compares the objects of the nth page with the objects of the (n−2)th page. When the above conditions are satisfied, the analysis processing unit 53 makes the objects of the nth page be monochrome.

Thereafter, the analysis processing unit 53 rasterizes the data of the nth page, and transmits the rasterized data to the input image processing unit 31. The object to be monochrome is converted into monochrome data at the point of time when the object is rasterized.

When n is 2 or less (first page and second page), the network communicating device 51 only writes the receive data on the main memory 28, but does not perform the comparison process.

Hereinafter, the MFP 48 performs the same process as the process performed after writing the raster data of one page on the page memory 30, as described in the first embodiment.

The analysis processing unit 53 may compare the pages of the nth page with the page before one page or the page after one page instead of comparing the (n−2)th, (n−1)th, and nth pages.

The analysis processing unit 53 may compare the nth page with the page 2 pages before or the page 2 pages after.

In addition, the analysis processing unit 53 omits Act B5 and Act B6, and may compare the (n−1)th page with the nth page. In this case, the storage area 79c for the (n−2)th page component is not necessary.

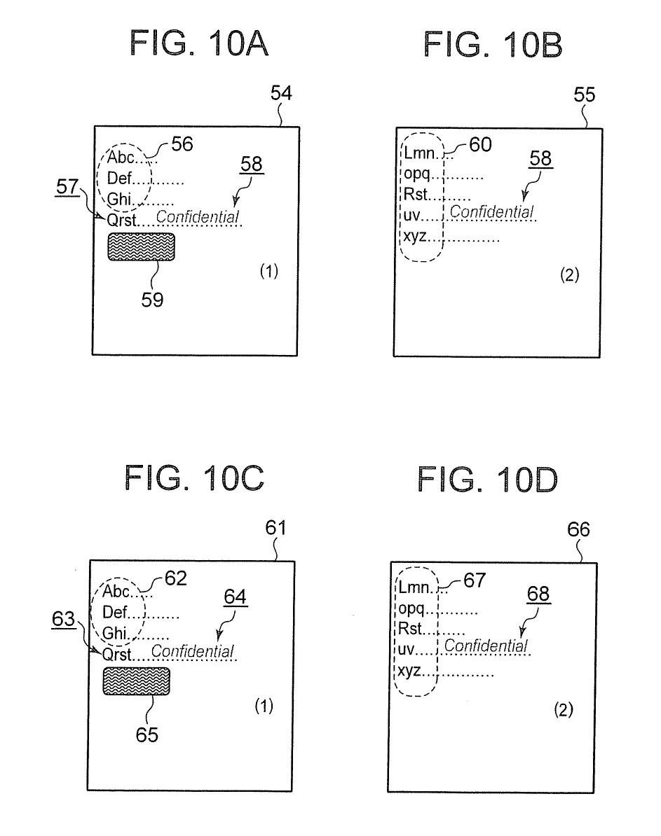

FIGS. 10A to 10D show an example of the input original document containing the color watermark and the paper on which the watermark is printed to be monochrome. In FIGS. 10A and 10B, the same reference numerals denote the same components.

The reference numerals 54 and 55 denote the original document data of the input original document. In FIGS. 10A and 10B, the components in the original document are displayed when the computer 50 prompts the display to display the original document data.

The input original document 54 includes a monochrome character array 56, a color character array 57, a color watermark pattern 58, and a color graphic 59.

The input original document 55 includes a monochrome character array 60 and the color watermark pattern 58.

FIG. 10C is a view illustrating the paper on which the input original document 54 shown in FIG. 10A is printed by the MFP 48. FIG. 10D is a view illustrating the paper on which the input original document 55 shown in FIG. 10B is printed by the MFP 48.

The paper displayed is the printed nth page obtained by the analysis processing unit 53 which compares the nth page with the (n−1)th and (n−2)th pages among the three continuous (n−2)th, (n−1)th, and nth pages.

As shown in FIG. 10C, the paper 61 includes a monochrome character array 62, a color character array 63, a color watermark pattern 64, and a color graphic 65. The paper 61 is output as a color page.

As shown in FIG. 10D, the paper 66 includes a monochrome character array 67 and a monochrome watermark pattern 68.

Comparing FIG. 10B with FIG. 10D, the input original document 55 includes the color object, but the paper 66 is output as the monochrome page.

The color portion is mixed in the input original document 55, but the color portion is treated as a monochrome object.

The computer 50 sets the input original document 54 to the (n−1)th page and the input original document 55 to the nth page, and transmits these input original documents to the MFP 48. The analysis processing unit 53 makes the color data of the input original document 55 of the nth page be monochrome, and prints out the paper 66.

The header and the footer are printed on an upper blank and a lower blank of the page surface, respectively. When the character strings inserted in the header and the footer are color, the color character strings written on the header and the footer are printed to be monochrome.

As described above, according to the image forming apparatus of the second embodiment, the color image of little importance can be printed to be monochrome.

Even when the color company logo or the color watermark is inserted in the header and the footer portions, it is possible to make the color company logo or the watermark be monochrome.

As a result, the color component of little importance can be printed by the monochrome printing at a low cost, so that the total cost can be reduced. It also contributes to the reduction of color toner consumption.

### Modified Example of Second Embodiment

The image forming apparatus according to a modified example of the second embodiment makes the watermark particularly attached in the center portion of the page be monochrome. The image forming apparatus according to the modified example of the second embodiment is also the MFP. The configuration of the MFP is substantially the same as that of the MFP 48.

In the second embodiment, it is determined whether or not there is an object with the same shape in the same position in the page. However, in the modified example, a process of making the comparison condition between the pages stricter is added in the analysis processing unit 53.

The flash ROM 27 previously holds the size of the pattern which has a magnitude equal to or larger than a predetermined value in the center portion of the received image.

The pattern size represents the height OH and the width OW of the object. In this modified example, the height OH and the width OW are previously set as the additional conditions.

The operation of the MFP in the modified example configured as described above is substantially the same as that of second embodiment.

The image processing unit 8 determines that the same color object is positioned in the center of the original document in plural pages. The image processing unit 8 determines that the sizes (width and height) of the same color objects are larger than the height OH and the width OW.

When the two determination results are affirmative, the image processing unit 8 determines the condition is satisfied, and makes the color object be monochrome. The image processing unit 8 performs the printing by switching the color and the monochrome using the output image processing unit 32.

The color watermark created by the computer 50 using the word processor software or the like effectively comes to be monochrome.

### Third Embodiment

In the first embodiment, the second embodiment, and the modified example thereof, the width and height values of the original document may be set via the user interface.

The image forming apparatus according to the third embodiment is also the MFP.

A function of changing the comparison condition using the console panel 1b is added in the control units 4 and 52. The console panel 1b displays on the screen the effect that the user is prompted to input the values of the width and the height of the original document.

The control units 4 and 52 reads the values set by the user using the console panel 1b. The input image processing unit 31 makes the peripheral area of the page wider or narrower according to the values of the width and the height of the set original document.

With such a configuration, the MFP according to the third embodiment operates similarly to the example in the first embodiment. The control unit 4 reads the color image on the input original document made of paper.

Alternatively, similarly to the example in the second embodiment, the MFP is configured such that the control unit 52 receives the PDL data from the computer 50 via the network 49, and reads the color image in the PDL data.

The control unit 52 determines whether or not there is color or monochrome in every page, and makes the unnecessary color object be monochrome.

The magnitude of the area mask for determining the color can be increased or decreased according to the size of the original document, the blank size of the original document, the size of the header/footer, and the like. The measurement accuracy can be increased. It is possible to deal with the various sizes of the original document.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications, and alterations should therefore be seen as within the scope of the present invention.

What is claimed is:

1. An image forming apparatus comprising:
a first memory which stores a page image of every page of an input original document;
a color printing processing unit which performs color printing on the page image stored in the first memory;
a monochrome printing processing unit which performs monochrome printing on the page image stored in the first memory;
a mask processing unit which masks a peripheral image of the page image stored in the first memory and generates an area image which is obtained by masking the peripheral image from the page image;
a determining unit which determines whether a color of the area image generated by the mask processing unit is color or monochrome; and
a printing control unit which prompts the color printing processing unit to print the image of the input original document when the determining unit determines that the area image is color, and prompts the monochrome printing processing unit to print the image of the input original document when the determining unit determines that the area image is monochrome.

2. The apparatus of claim 1, further comprising:
an image reading unit which scans the input original document, and generates image signals corresponding to a plurality of colors; and
a threshold value memory which stores a threshold value of the number of pixels,
wherein the determining unit compares a magnitude of the number of the pixel signals corresponding to a plurality of colors generated by the image reading unit with a magnitude of the threshold value of the threshold value memory, and determines whether the area image is color or monochrome.

3. The apparatus of claim 1, wherein the mask process performed by the mask processing unit is to mask an image which is positioned in a predetermined range from the top, bottom, left, and right ends of the input original document toward the center of the input original document.

4. The apparatus of claim 1, further comprising:
a second memory which stores information on the number of printing times of the color printing processing unit, information on the number of printing times of the monochrome printing processing unit, and a plurality pieces of fee scale information; and
a fee processing unit which reads each piece of the information on the number of printing times and calculates a charging fee by multiplying each piece of the information on the number of printing times by one piece of the fee scale information.

5. The apparatus of claim 1, further comprising:
a console panel which displays a user interface screen for user interaction and outputs a value which is input or selected,
wherein the mask process performed by the mask processing unit is to make the width of the peripheral image be widened or narrowed by the value which is input or selected through the console panel.

6. An image forming apparatus comprising:
a network communicating device which receives image data via a network, where the image data includes a plurality of objects to be drawn and is described in the unit of page;
a second memory which stores the image data of a plurality of pages received by the network communicating device;
a third memory which stores bitmap image data in the unit of page obtained from the image data of the plurality of pages stored in the second memory;
a color printing processing unit which performs color printing on the bitmap image of the third memory;
an analyzing unit which analyzes the image data of the plurality of pages of the second memory to generate the bitmap image data of the third memory;
a comparing and determining unit which compares and determines whether the same color objects are included in the continuous pages analyzed by the analyzing unit;
a color processing unit which eliminates color information from the color objects which are included in the image data of the plurality of pages of the second memory; and
a printing control unit which prompts the color processing unit to make the same color objects be monochrome when the comparing and determining unit determines that the same color objects are included, and prompts the color printing processing unit to print a page including the monochrome object.

7. The apparatus of claim 6, further comprising:
a position and size information memory which stores size information of a pattern having a size equal to or larger than a predetermined value in the center portion of the received image,
wherein the comparison performed by the comparing and determining unit is to determine whether or not the same color objects are positioned on the position information and whether or not the sizes of the same color objects are larger than the size information.

8. The apparatus of claim 6, further comprising:
a console panel which displays a user interface screen for user interaction and outputs a value which is input or selected,
wherein the comparison performed by the comparing and determining unit is to change the number of the continuous pages by a value which is input or selected through the console panel.

9. The apparatus of claim 6, further comprising:
a monochrome printing processing unit which performs monochrome printing on the bitmap image of the third memory;
a fourth memory which stores information on the number of printing times of the monochrome printing processing unit, information on the number of printing times of the color printing processing unit, and a plurality of fee scale information; and
a fee processing unit which reads each piece of the information on the number of printing times and calculates a charging fee by multiplying each piece of the information on the number of printing times by one piece of the fee scale information.

10. The apparatus of claim 7, further comprising:
a console panel which displays a user interface screen for user interaction and outputs a value which is input or selected,
wherein the position information and the size information stored in the position and size information memory are set by values which are input or selected through the console panel, and the comparison performed by the comparing and determining unit is performed by using the set position information and the set size information.

11. An image forming method comprising the steps of:
writing a page image in every page of an input original document in a first memory by an image reading unit which scans the original document and generates pixel signals corresponding to a plurality of colors;
generating an area image which is obtained by masking a peripheral image from the page image by a mask processing unit which masks the peripheral image of the page image stored in the first memory;
determining a color of the area image, which is generated by the mask processing unit, by the determining unit which determines whether data is color or monochrome; and
making a printing control unit for controlling image printing prompt a color printing processing unit for color printing to print an image of the input original document when the determining unit determines that the area image is color, and prompt a monochrome printing processing unit for monochrome printing to print the image of the input original document when the determining unit determines that the area image is monochrome.

12. The method of claim 11, wherein the determination performed by the determining unit is to compare a magnitude of the number of the pixel signals corresponding to the plurality of colors generated by the image reading unit with a magnitude of a threshold value of the number of pixels read from a threshold value memory, and to determine whether the color of the area image is color or monochrome.

13. The method of claim 11, wherein the mask process performed by the mask processing unit is to mask an image which is positioned in a predetermined range from the top, bottom, left, and right ends of the input original document toward the center of the input original document.

14. The method of claim 11, wherein an MPU reads information on the number of printing times of the color printing processing unit and information on the number of printing times of the monochrome printing processing unit from a second memory, and calculates a charging fee by multiplying each piece of the information on the number of printing times by fee scale information held previously.

15. The method of claim 11, wherein the mask process performed by the mask processing unit is to make a width of the peripheral image be widened or narrowed by a value which is input or selected through a console panel displaying a user interface screen for user interaction.

16. An image forming method comprising the steps of:
writing image data of a plurality of pages to a second memory by a network communicating device which receives the image data via a network, the image data including a plurality of objects to be drawn and being described in the unit of page;
generating bitmap image data in the unit of page from the image data of the plurality of pages by an analyzing unit, where the analyzing unit analyzes the image data of the plurality of pages of the second memory;
comparing and determining whether or not the same color objects are included in continuous pages by a comparing and determining unit;
making the same color objects be monochrome in a color processing unit when the comparing and determining unit determines that the same color objects are included, where the color processing unit eliminates color information from the color objects included in the image data of the plurality of pages of the second memory; and
prompting a printing control unit to make a color printing processing unit print a page which includes the monochrome object obtained by the color processing unit, where the printing control unit controls printing of the color printing processing unit which performs color printing on the bitmap image of the third memory.

17. The method of claim 16, wherein the comparison performed by the comparing and determining unit is to read size information of a pattern from a position and size information memory, the pattern having a size equal to or larger than a predetermined value in the center portion of the received image, and to determine whether or not the same color objects are positioned on the position information and whether or not the sizes of the same color objects are larger than the size information.

18. The method of claim 16, wherein the comparison performed by the comparing and determining unit is to change the number of the continuous pages by a value which is input or selected through a console panel displaying a user interface screen for user interaction.

19. The method of claim 16, wherein an MPU reads information on the number of printing times of a monochrome printing processing unit, which performs a monochrome printing on the bitmap image of the third memory, and information on the number of printing times of a color printing processing unit from a fourth memory, and calculates a charging fee by multiplying each piece of the information on the number of printing times by fee scale information held previously.

20. The method of claim 17, wherein the position information and the size information stored in the position and size information memory are set by values which are input or selected through the console panel, and
wherein the comparison performed by the comparing and determining unit is performed by using the set position information and the set size information.
